(19) United States
(12) Patent Application Publication
(10) Pub. No.: US 2026/0027680 A1
(43) Pub. Date: Jan. 29, 2026

(54) TOOL

(71) Applicant: KYOTO TOOL CO., LTD., Kyoto-shi, Kyoto (JP)

(72) Inventors: Kensuke ASAHINA, Kuse-gun (JP); Tadashi MAEKAWA, Kuse-gun (JP)

(21) Appl. No.: 18/997,934

(22) PCT Filed: Jul. 27, 2022
(86) PCT No.: PCT/JP2022/028886

§ 371 Date: Jan. 23, 2025

(51) Int. Cl. B25B 15/02; B25B 23/00; G06K 19/07

(52) U.S. Cl. CPC B25B 15/02; G06K 19/0723; B25B 23/0042

(57) ABSTRACT

In order to enable communication with a reader regardless of an orientation and a posture of a tool, the tool includes: a handle to be gripped by an operator; a force application member provided on a distal end side of the handle; an attachment member provided on a rear end side of the handle; and an electronic tag attached to the attachment member or a rear end portion of the handle and continuously or intermittently provided along a circumferential direction.

### TECHNICAL FIELD

The present invention relates to a tool such as a screwdriver.

### BACKGROUND ART

For example, in an aircraft maintenance site or the like, loss of a tool such as a screwdriver is directly linked to safety, and therefore, thorough tool management is performed.

As a conventional screwdriver, as described in Patent Literature 1, there is a screwdriver configured to be able to wirelessly communicate between an electronic tag and a reader by inserting a plug into a handle and disposing the electronic tag in a rectangular groove formed in this plug. Such a configuration contributes to management of, for example, whether the screwdriver is returned to a tool box.

However, in the screwdriver disclosed in Patent Literature 1, since a radio wave transmitted from the electronic tag is mainly directed in a direction in which the groove opens, if an opening of the groove faces downward, for example, depending on an orientation and a posture, there may be a problem that communication with the reader becomes impossible.

### CITATION LIST

### Patent Literature

Patent Literature 1: U.S. Pat. No. 8,870,078

### SUMMARY OF INVENTION

### Technical Problem

Therefore, the present invention has been made to solve the above-described problem, and a main object thereof is to provide a tool capable of communicating with a reader regardless of an orientation and a posture of the tool.

### Solution to Problem

That is, a tool according to the present invention includes: a handle to be gripped by an operator; a force application member provided on a distal end side of the handle; an attachment member provided on a rear end side of the handle; and an electronic tag attached to the attachment member, and provided continuously or intermittently along a circumferential direction.

According to the tool configured as described above, since the electronic tag is provided continuously or intermittently along the circumferential direction, it is possible to communicate with a reader regardless of an orientation and a posture of the tool.

Moreover, since the electronic tag is attached to the rear end portion of the handle or the attachment member provided on the rear end side of the handle, a force is less likely to be applied to the electronic tag at the time of work, and damage or the like of the electronic tag can be prevented.

In order to transmit a radio wave in all directions, an aspect is also conceivable in which the electronic tag is wound over an entire circumference of the tool, but a configuration in which the electronic tag is simply wound causes another problem such as an increase in a size of the tool.

Therefore, it is preferable that a groove is continuously or intermittently formed on an outer peripheral surface of the attachment member along the circumferential direction, and that the electronic tag is provided in the groove.

With such a configuration, since the electronic tag is provided in the groove on the outer peripheral surface of the attachment member, it is possible to transmit the radio wave in all directions while keeping the size of the tool compact.

It is preferable that the groove is continuously provided over an entire circumference of the outer peripheral surface of the attachment member, and that the electronic tag is wound around the attachment member along the groove.

With such a configuration, the radio wave from the electronic tag can be transmitted in all directions, and communication between the electronic tag and the reader can be made more reliable.

Since the electronic tag is broken when water or the like touches the electronic tag, it is preferable to further include a seal member that keeps the groove airtight.

In a case where the attachment member is made of metal such as a buttock metal, when the electronic tag is attached to the attachment member, a part of the radio wave transmitted from the electronic tag is reflected by the attachment member, so that the radio wave is canceled and weakened, and there arises a problem that stability of communication is impaired.

Therefore, when the attachment member is made of metal, it is preferable that the tool further comprises a non-metallic spacer provided in the groove, and that the electronic tag is attached to the attachment member via the spacer.

With such a configuration, since the electronic tag is attached via the non-metallic spacer, it is possible to prevent the radio wave transmitted from the electronic tag from being reflected by a shaft body, and it is possible to ensure the stability of communication.

In order to further suppress the above-described reflection of the radio wave and the like, it is preferable that the attachment member is made of resin.

In the case where the electronic tag is provided in the groove on the outer peripheral surface of the attachment member as described above, a length of the antenna configuring the electronic tag is restricted by an outer diameter of the attachment member, but if a sufficient length cannot be secured, there arises a problem that a communication distance becomes insufficient.

Therefore, it is preferable that the rear end portion of the handle has an accommodation space that accommodates the electronic tag.

With such a configuration, it is possible to increase the circumferential length of the antenna by providing the antenna at the rear end portion of the handle rather than providing the antenna in the attachment member, and thus, it is possible to increase the communication distance.

It is preferable that the accommodation space is a space obtained by recessing a rear end surface of the handle.

This enables the accommodation space to be easily formed.

As a more specific aspect, an aspect can be mentioned in which the tool further includes an annular substrate provided in the accommodation space, wherein the electronic tag has an annular shape provided on the substrate.

As another aspect for increasing the circumferential length of the antenna, an aspect can be mentioned in which the electronic tag is provided on a closing surface that closes a rear end opening of the handle in the attachment member.

With such a configuration, since the electronic tag is provided on the closing surface, the circumferential length of the antenna can be made longer and the communication distance can be extended as compared with the configuration in which the electronic tag is provided on the outer peripheral surface of the attachment member.

It is preferable that the electronic tag is accommodated in an accommodation space obtained by recessing the closing surface.

With such a configuration in which the accommodation space is provided on the closing surface, the handling is easier and capital investment is reduced as compared with the configuration in which the groove is provided on the outer peripheral surface of the attachment member.

In the case where the electronic tag is provided in the attachment member, when an attempt is made to mold (for example, insert molding) a grip after the attachment member is inserted into the handle, there is a risk that the electronic tag is broken due to application of a force at the time of molding. However, it is preferable to mold the grip before the attachment member is inserted.

However, in this case, an internal space of the handle is crushed at the time of molding the grip, and there arises another problem that it becomes difficult to insert the attachment member without difficulty.

Therefore, it is preferable that the tool further includes a tubular spacer fitted into the handle through a rear end opening of the handle, and that the attachment member is inserted into the tubular spacer.

According to such a configuration, the tubular spacer is first fitted into the handle before the attachment member is inserted, and the grip is molded in this state, by which the internal space of the handle can be prevented from being crushed.

In addition, by providing such a tubular spacer, the attachment member can be reduced in diameter, and thus, for example, when the electronic tag is attached to the attachment member, handling is easy.

### Advantageous Effects of Invention

According to the present invention constituted in this manner, it is possible to communicate with a reader regardless of an orientation and a posture of a tool.

### BRIEF DESCRIPTION OF DRAWINGS

FIG. 1 is a perspective view schematically illustrating a configuration of a tool according to a first embodiment of the present invention.

FIG. 2 is a cross-sectional view schematically illustrating a configuration of the tool of the same embodiment.

FIG. 3 is an exploded perspective view schematically illustrating the configuration of the tool of the same embodiment.

FIG. 4 is a perspective view schematically illustrating a configuration of an electronic tag of the same embodiment.

FIG. 5 is a perspective view schematically illustrating a configuration of an electronic tag in a modification of the first embodiment.

FIG. 6 is an exploded perspective view schematically illustrating a configuration of a tool according to a second embodiment of the present invention.

FIG. 7 is an exploded perspective view schematically illustrating a configuration of an electronic tag according to a third embodiment of the present invention.

FIG. 8 is a cross-sectional view schematically illustrating a configuration of a tool according to a modification of the third embodiment.

FIG. 9 is a perspective view schematically illustrating a configuration of a tool according to another embodiment.

FIG. 10 is a perspective view schematically illustrating a configuration of a tool of still another embodiment.

### DESCRIPTION OF EMBODIMENTS

### First Embodiment

Hereinafter, a first embodiment of a tool according to the present invention will be described.

The tool according to the present embodiment is used at a maintenance site of, for example, an aircraft, a vehicle, a railway vehicle, a ship, or the like, and is a screwdriver used for fastening work of a fastener.

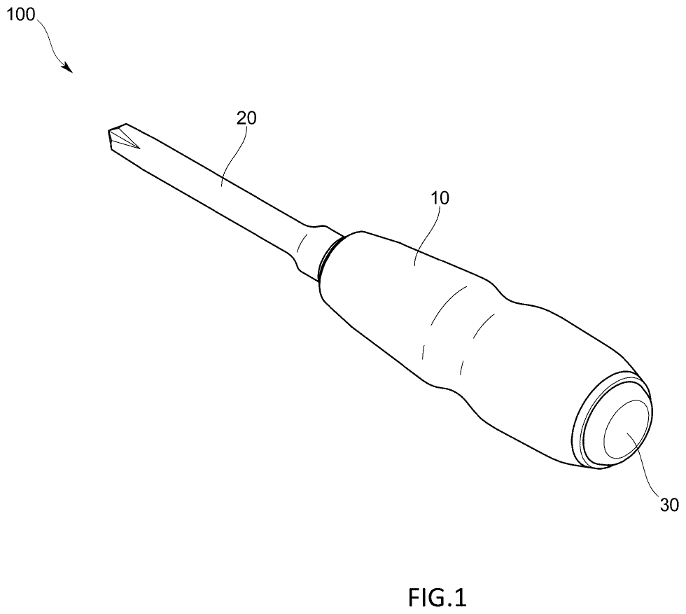

As illustrated in FIG. 1, a screwdriver 100 includes a handle 10 to be gripped by an operator, a force application member 20 provided on a distal end side of the handle 10, and an attachment member 30 provided on a rear end side of the handle 10. Note that although FIG. 1 illustrates a Phillips screwdriver as one example of the screwdriver 100, a flathead screwdriver, a nut screwdriver, a torque screwdriver, or the like may be used.

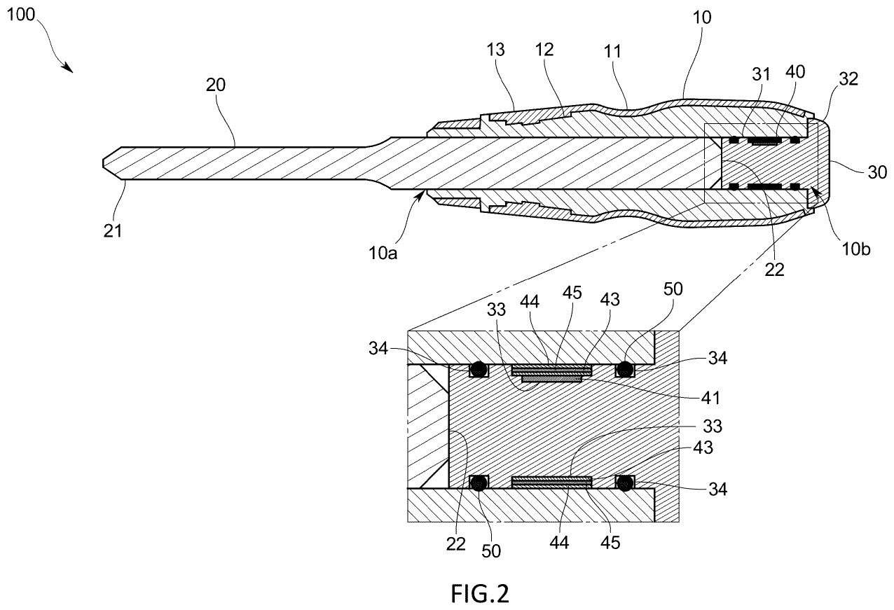

As illustrated in FIG. 2, the handle 10 has a grip portion 11 that is a portion to be gripped by the operator, and has an elongated shape here.

As illustrated in FIG. 2, the handle 10 of the present embodiment includes a main body 12 made of, for example, a hard resin, and a grip 13 made of, for example, a soft resin that covers an outer peripheral surface of the main body 12. However, the handle 10 is not necessarily configured of the main body 12 and the grip 13, and may be configured, for example, by one member or by three or more members, and various materials such as resin or wood may be used as a material.

The handle 10 here has a tubular shape, and the force application member 20 to be described later is inserted into a distal end-side opening 10a, and the attachment member 30 to be described later is attached to a rear end-side opening 10b.

As illustrated in FIG. 2, the force application member 20 is configured such that a distal end portion 21 functions as a portion for applying a force to an object such as a fastener, and a base end portion 22 is inserted into the handle 10 through the distal end-side opening 10a of the handle 10, and here, the force application member 20 is formed of a metal shaft body having an elongated shape here.

As illustrated in FIG. 2, the attachment member 30 closes the tubular rear end-side opening 10b, and has an insertion body 31 inserted into the handle 10 through the rear end-side opening 10b of the handle 10, and a lid body 32 closing the rear end-side opening 10b.

The attachment member 30 of the present embodiment is configured by integrally forming the insertion body 31 and the lid body 32, and is specifically made of resin. Note that the attachment member 30 is not necessarily made of resin, and various materials may be used as long as it does not reflect a radio wave, such as, for example, wood.

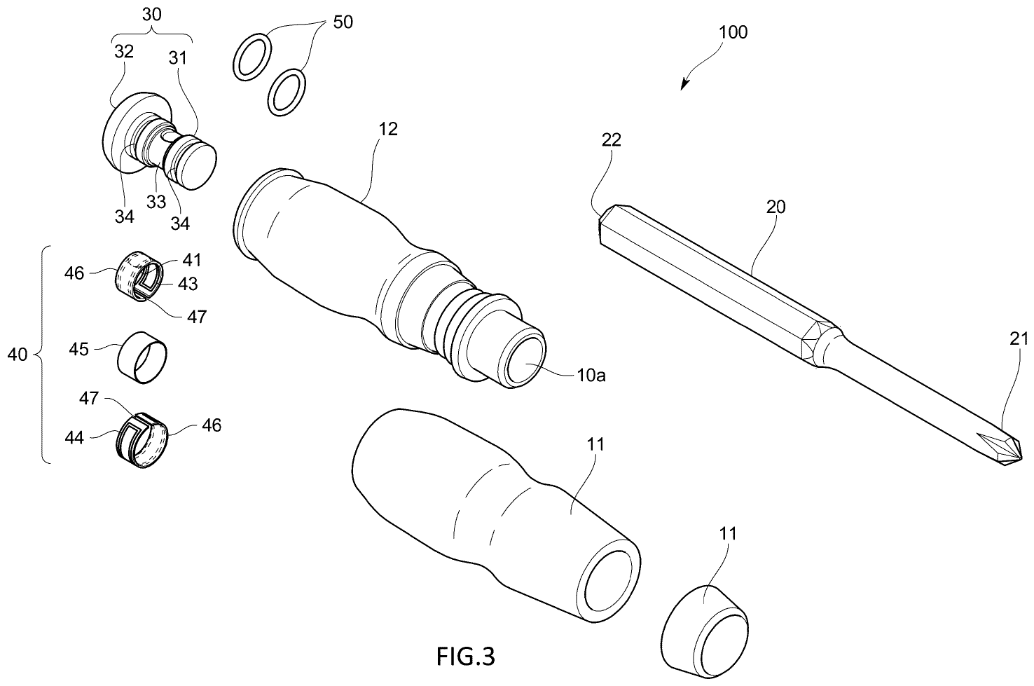

However, as illustrated in FIGS. 2 and 3, the screwdriver 100 of the present embodiment further includes an electronic tag 40 attached to the attachment member 30 described above and continuously provided along a circumferential direction. The circumferential direction is a direction that goes around with an axial direction of the handle 10 as a central axis.

More specifically, in this embodiment, a groove 33 continuously extending along the circumferential direction is formed on an outer peripheral surface of the attachment member 30 described above, and the electronic tag 40 is provided in the groove 33.

The groove 33 of the present embodiment has an annular shape continuously provided over an entire circumference of the outer peripheral surface of the attachment member 30, and specifically, is formed on an outer peripheral surface of the insertion body 31 described above.

Small grooves 34 are further provided on the distal end side and the rear end side of the groove 33 on the outer peripheral surface of the insertion body 31, and seal members 50 such as O-rings that keep the groove 33 airtight are provided in these small grooves 34.

The electronic tag 40 is wound around the attachment member 30 along the groove 33 described above, wirelessly communicates with a reader (not illustrated), and stores various types of information readable by the reader.

Specifically, as illustrated in FIG. 3, this electronic tag 40 includes at least an IC chip 41 and an antenna unit 42 provided with the IC chip 41.

In this embodiment, the antenna unit 42 includes an inner antenna 43 located on a radially inner side and an outer antenna 44 located on a radially outer side of the inner antenna 43, and an insulating sheet 45 is interposed between the inner antenna 43 and the outer antenna 44.

In this embodiment, the IC chip 41 is connected to the inner antenna 43 and is disposed so as to be accommodated in a recessed portion formed in the insertion body 31 described above. Note that the IC chip 41 may be connected to the outer antenna 44 instead of the inner antenna 43.

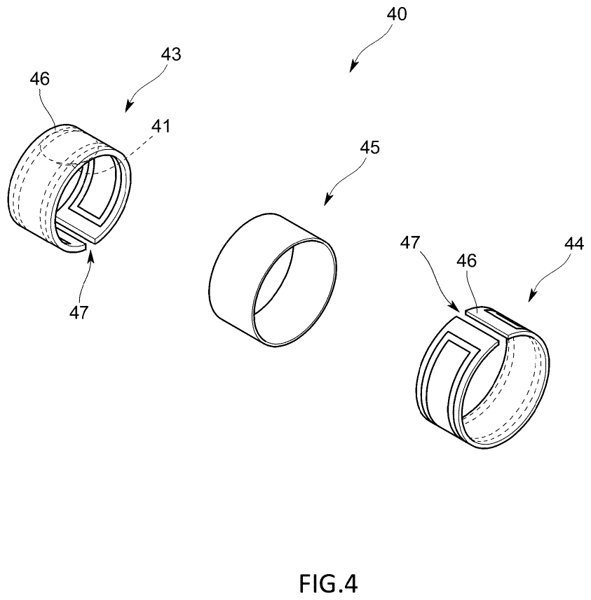

As illustrated in FIG. 4, the inner antenna 43 and the outer antenna 44 are each formed on an antenna substrate 46 such as a flexible substrate.

More specifically, the antenna substrate 46 has a C-shaped cross-sectional shape obtained by cutting out a part of a circle orthogonal to an axial direction of the screwdriver 100.

In the present embodiment, a cut-out portion 47 of the antenna substrate 46 in which the inner antenna 43 is formed, and a cut-out portion 47 of the antenna substrate 46 in which the outer antenna 44 is formed are disposed so as to face in opposite directions to each other.

The inner antenna 43 and the outer antenna 44 are formed of, for example, a photoresist, and form a closed loop. Note that a method for forming the inner antenna 43 and the outer antenna 44 is not necessarily limited to the photoresist, and various forming methods such as cutting and laser processing may be adopted.

The inner antenna 43 and the outer antenna 44 of the present embodiment are each formed of four sides surrounding a rectangular region, and are disposed such that the rectangular region surrounded by the inner antenna 43 and the rectangular region surrounded by the outer antenna 44 face in opposite directions to each other.

Note that the shapes and the dispositions of the inner antenna 43 and the outer antenna 44, and the shapes and the dispositions of the antenna substrates 46 are not limited thereto, and may be appropriately changed.

According to the screwdriver 100 configured as described above, since the electronic tag 40 is continuously provided along the circumferential direction, it is possible to communicate with the reader regardless of the orientation and the posture of the screwdriver 100.

Moreover, since the electronic tag 40 is attached to the attachment member 30 provided on the rear end side of the handle 10, a force is less likely to be applied to the electronic tag 40 at the time of work, and damage or the like of the electronic tag 40 can be prevented.

In addition, since the electronic tag 40 is provided in the annular groove 33 formed in the attachment member 30, it is possible to transmit the radio wave in all directions while keeping the size of the screwdriver 100 compact.

Furthermore, since the seal members 50 that keep the groove 33 airtight is provided, it is possible to prevent moisture from entering the groove 33 and breaking the electronic tag 40.

### Modification of First Embodiment

Note that the present invention is not limited to the first embodiment.

For example, in the above embodiment, the attachment member 30 has been described as being made of resin, but the attachment member 30 is made of, for example, metal, and may be specifically a buttock metal for hitting the screwdriver 100 with a hammer or the like.

In this case, when the electronic tag 40 is attached to the attachment member 30 made of metal, a problem occurs that a part of the radio wave transmitted from the electronic tag 40 is reflected by the attachment member 30, so that the radio wave is canceled and weakened, and stability of communication is impaired.

Therefore, it is preferable that the tool 100 (the screwdriver) in this case further includes a non-metallic spacer provided in the groove 33, and that the electronic tag 40 is attached to the attachment member 30 via the spacer.

With such a configuration, since the electronic tag 40 is attached via the non-metallic spacer, it is possible to prevent the radio wave transmitted from the electronic tag 40 from being reflected by the shaft body, and it is possible to ensure the stability of communication.

In addition, the groove 33 formed in the attachment member 30 is continuously formed over the entire circumferential direction in the above-described embodiment, but may be continuously formed while leaving a part in the circumferential direction, or may be intermittently formed over the circumferential direction.

According to this shape of the groove 33, the electronic tag 40 may also be continuously formed while leaving a part in the circumferential direction, or may also be intermittently formed over the circumferential direction.

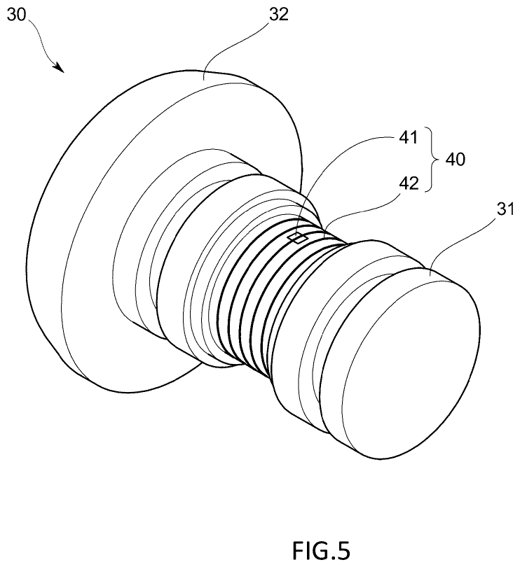

Furthermore, as illustrated in FIG. 5, the antenna unit 42 may have a spiral shape as the electronic tag 40.

With such a configuration, a length of the antenna unit 42 can be increased, and a communication distance can be increased.

### Second Embodiment

Next, a second embodiment of a tool according to the present invention will be described.

A tool 100 according to the present embodiment is a screwdriver similarly to the first embodiment, and since a configuration and a disposition of an electronic tag 40 are different from those of the first embodiment, this point will be described.

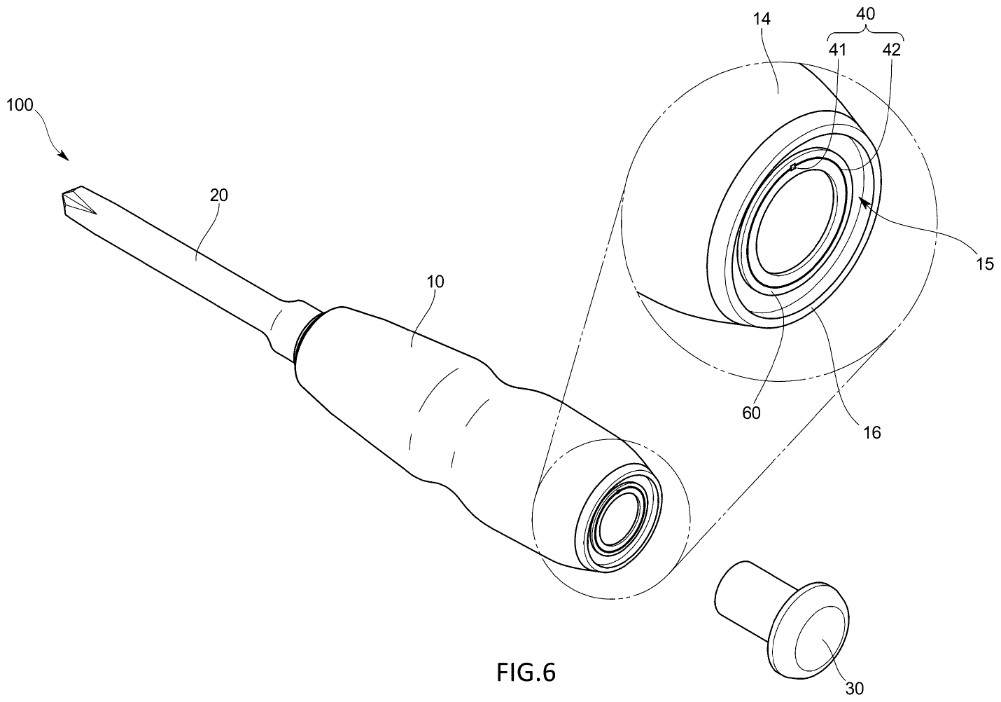

As illustrated in FIG. 6, the electronic tag 40 of the present embodiment is provided at a rear end portion 14 of a handle 10.

More specifically, the rear end portion 14 of the handle 10 has an accommodation space 15 for accommodating the electronic tag 40, and an attachment member 30 is attached to the rear end portion 14 in a state where the electronic tag 40 is accommodated in the accommodation space 15.

The accommodation space 15 is a space formed by recessing a rear end surface 16 of the handle 10, in other words, an attachment target surface to which the attachment member 30 is attached, and has, for example, an annular shape.

Here, an annular substrate is provided in the accommodation space 15, and the electronic tag 40 is provided on the substrate.

The electronic tag 40 is electrically connected to the substrate, and specifically includes an IC chip 41 and an antenna unit 42 provided with the IC chip.

The antenna unit 42 here has an annular shape continuously provided along a circumferential direction. Note that the circumferential direction is a direction that goes around with an axial direction of the handle 10 as a central axis.

The attachment member 30 is made of, for example, resin, and closes the above-described accommodation space 15 by being attached to the rear end portion 14 of the handle 10.

With such a configuration, the electronic tag 40 of the present embodiment is disposed to be interposed between the rear end portion 14 of the handle 10 and the attachment member 30.

According to the screwdriver 100 configured as described above, since the electronic tag 40 is continuously provided along the circumferential direction, it is possible to communicate with the reader regardless of the orientation and the posture of the screwdriver 100.

Moreover, since the electronic tag 40 is attached to the attachment member 30 provided at the rear end portion 14 of the handle 10, a force is less likely to be applied to the electronic tag 40 at the time of work, and damage or the like of the electronic tag 40 can be prevented.

In addition, since the antenna of the electronic tag 40 has the annular shape, it is possible to transmit a radio wave in all directions while keeping a size of the screwdriver 100 compact.

Furthermore, as compared with the configuration in which the electronic tag 40 is provided on the attachment member 30 as in the first embodiment, the configuration in which the electronic tag 40 is provided on the rear end portion 14 of the handle 10 can increase a circumferential length of the antenna unit 42, and a communication distance can be extended accordingly.

### Modification of Second Embodiment

For example, in the above-described embodiment, the accommodation space 15 is provided at the rear end portion 14, but the rear end surface 16 of the handle 10 may be, for example, a flat surface, and the accommodation space 15 may be provided by recessing a closing surface of the attachment member 30, the closing surface closing a rear end-side opening 10b of the handle 10.

In this case, the electronic tag 40 is accommodated inside the accommodation space 15 by attaching the attachment member 30 to the rear end portion 14 in a state where the electronic tag 40 is provided on the flat rear end surface 16 of the rear end portion 14.

Note that the accommodation space 15 may be formed by recessing both the rear end surface 16 of the handle 10 and the closing surface of the attachment member 30.

Further, the accommodation space 15 formed at the rear end portion 14 of the handle 10 has an annular shape in the above-described embodiment, but may be continuously formed while leaving a part in the circumferential direction, or may be intermittently formed over the circumferential direction.

According to the shape of the accommodation space 15, the antenna configuring the electronic tag 40 may also be continuously formed while leaving a part in the circumferential direction, or may also be intermittently formed over the circumferential direction.

Furthermore, also in the screwdriver 100 in the second embodiment, a seal member 50 such as an O-ring may be provided between the rear end portion 14 of the handle 10 and the attachment member 30 to keep the accommodation space 15 airtight.

### Third Embodiment

Next, a third embodiment of the tool according to the present invention will be described.

A tool 100 according to the present embodiment is a screwdriver similarly to each of the above-described embodiments, and since a configuration and a disposition of an electronic tag 40 are different from those of the first embodiment, this point will be described.

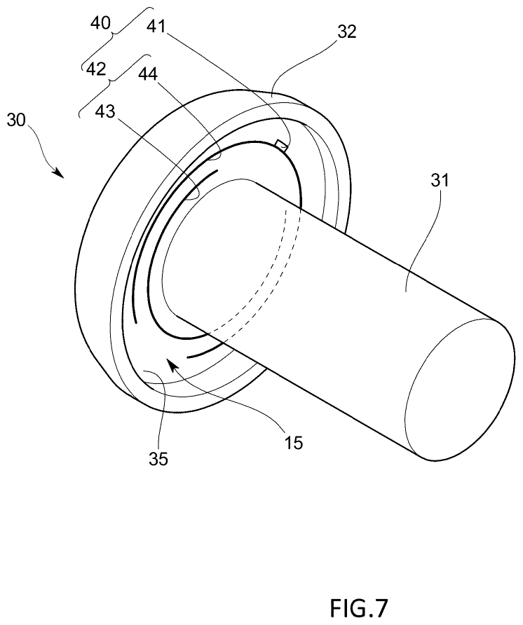

As illustrated in FIG. 7, the electronic tag 40 of the present embodiment is provided with an accommodation space 15 by recessing a closing surface 35 of the attachment member 30, the closing surface 35 closing a rear end-side opening 10b of the handle 10, and the electronic tag 40 is accommodated in this accommodation space 15.

The electronic tag 40 has an IC chip 41 and an antenna unit 42 continuously provided along a circumferential direction, and the antenna unit 42 is configured of an inner antenna 43 and an outer antenna 44. Note that the IC chip 41 is provided in the outer antenna 44 in this embodiment, but may be provided in the inner antenna 43.

These inner antenna 43 and outer antenna 44 each have a C-shaped cross-sectional shape obtained by cutting out a part of a circle orthogonal to an axial direction of the screwdriver 100, and are disposed such that cut-out portions face in opposite directions to each other.

According to the screwdriver 100 configured as described above, since the antenna unit 42 is continuously provided along the circumferential direction, it is possible to communicate with a reader regardless of an orientation and a posture of the screwdriver 100.

In addition, since the electronic tag 40 is accommodated in the accommodation space 15 provided on the closing surface 35 of the attachment member 30, circumferential lengths of the inner antenna 42 and the outer antenna 43 can be made longer and a communication distance can be extended as compared with the configuration in which the groove 33 is provided on the outer peripheral surface of the attachment member 30 as in the first embodiment.

By the way, in the configuration in which the electronic tag 40 is provided on the handle 10 as in the second embodiment, the handle 10 configured of a main body 12 and a grip 13 is conveyed to a work place where the electronic tag 40 is stuck, and the attachment member 30 is attached after the handle 10 to which the electronic tag 40 has been stuck is returned.

On the other hand, in the configuration in which the electronic tag 40 is provided in the attachment member 30 as in the present embodiment, the attachment member 30 may be conveyed to the work place where the electronic tag 40 is stuck, and the attachment member 30 to which the electronic tag 40 has been stuck may be returned. Therefore, a transportation cost and transportation time can be reduced as compared with the aspect in which the handle 10 is treated as in the second embodiment.

### Modification of Third Embodiment

In the case where the electronic tag 40 is provided in the attachment member 30, when the attachment member 30 is inserted into the main body 12 through the rear end-side opening 10b of the handle 10 and then the grip 13 is to be molded (for example, insert-molded) in the main body 12, there is a risk that the electronic tag 40 is broken by application of a force at the time of molding, but it is preferable to mold the grip 13 before the attachment member 30 is inserted.

However, in this case, an internal space of the main body 12 is crushed at the time of molding the grip 13, and there arises another problem that it becomes difficult to insert the attachment member 30 without difficulty.

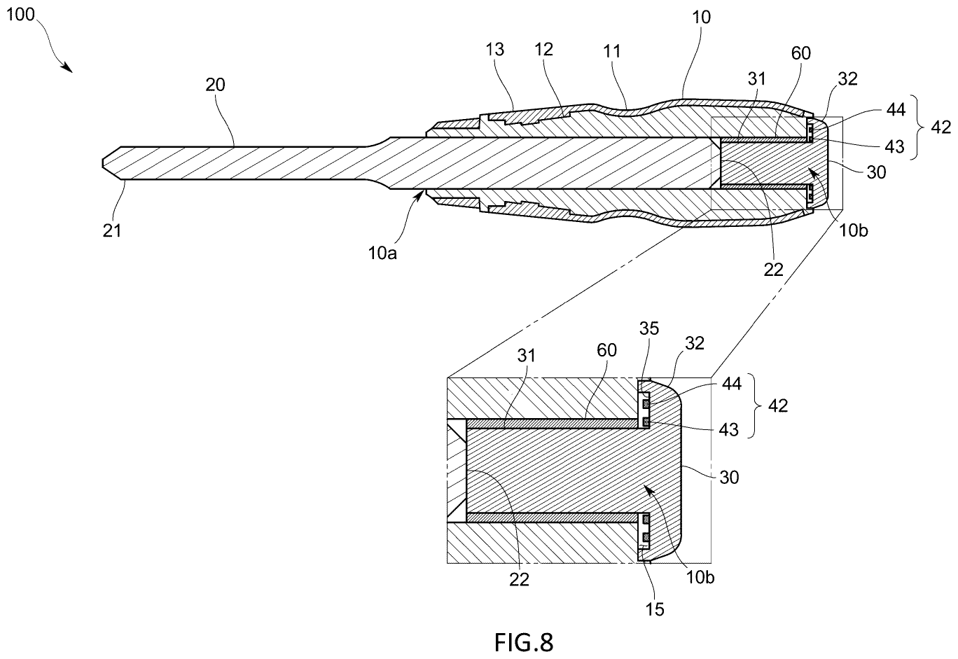

Therefore, as illustrated in FIG. 8, the tool 100 may be configured to further include a tubular spacer 60 fitted into the main body 12 through the rear end opening 10b of the handle 10, and to insert the attachment member 30 into the tubular spacer 60.

According to such a configuration, the tubular spacer 60 is first fitted into the main body 12 before the attachment member 30 is inserted, and the grip 13 is molded in the main body 12 in this state, by which the internal space of the main body 12 can be prevented from being crushed.

Moreover, since an insertion body 31 of the attachment member 30 can be reduced in diameter by providing the above-described tubular spacer 60, the insertion body 31 is less likely to be an obstacle when, for example, the electronic tag 40 is attached to the closing surface 35 of the attachment member 30, and the handling is further facilitated.

### Other Embodiments

Note that the present invention is not limited to the above-described embodiments.

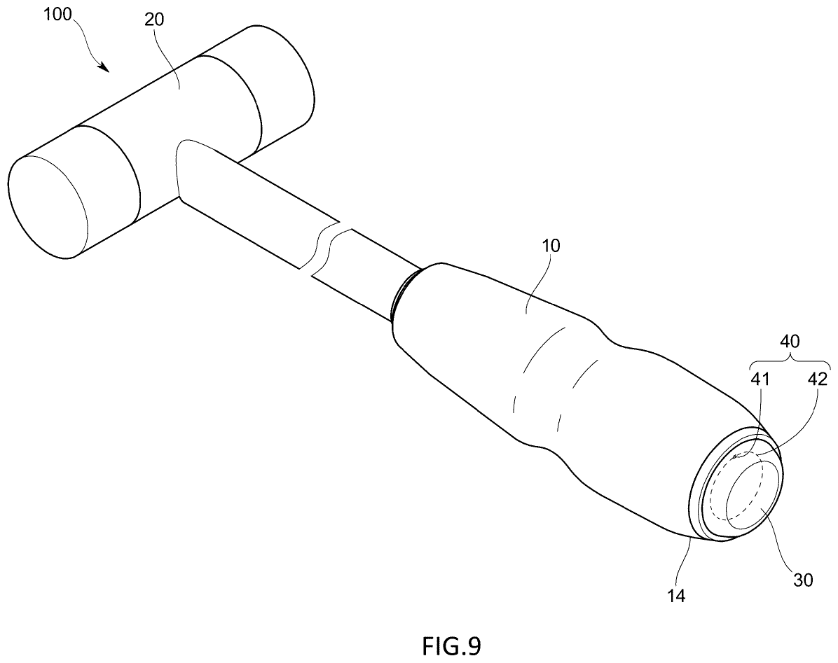

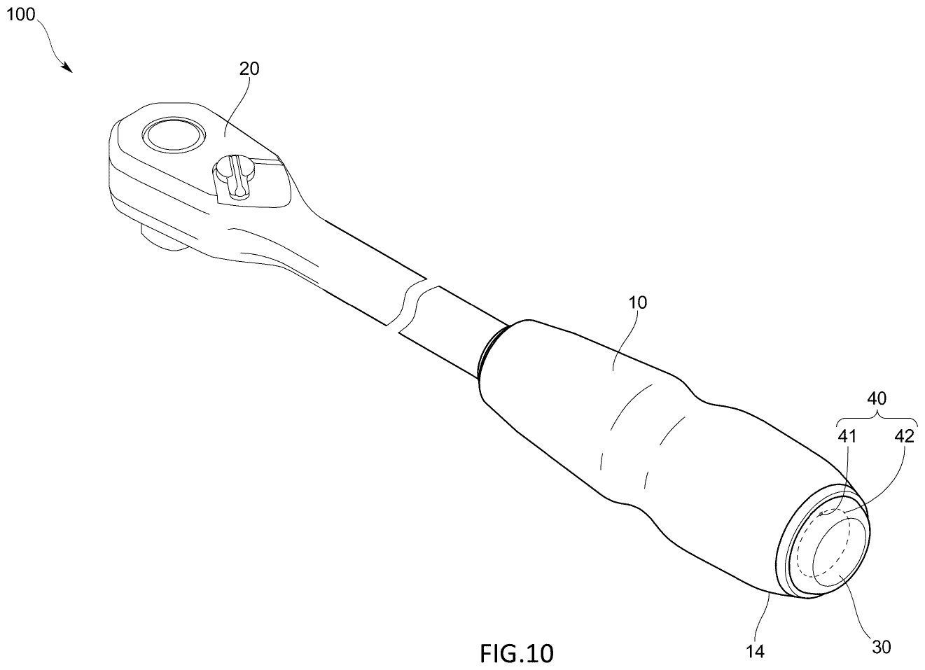

For example, in each of the above embodiments, the screwdriver is taken as the tool 100. However, the tool 100 according to the present invention may be a ratchet illustrated in FIG. 9, a hammer illustrated in FIG. 10, or the like as long as the tool includes a handle 10, a force application member 20, and an attachment member 30. These tools 100 also include an electronic tag 40 attached to the attachment member 30 or a rear end portion 14 of the handle 10 and provided continuously or intermittently along a circumferential direction.

In addition, the present invention is not limited to the above-described embodiments, and it goes without saying that various modifications can be made without departing from the spirit of the present invention.

### INDUSTRIAL APPLICABILITY

According to the present invention, it is possible to communicate with a reader regardless of an orientation and a posture of a tool.

### REFERENCE CHARACTERS LIST

100 tool (screwdriver)
10 handle
11 grip portion
12 main body
13 grip
14 rear end portion
20 force application member
30 attachment member
33 groove
40 electronic tag
41 IC chip
42 antenna unit
50 seal member

1. A tool comprising:
a handle to be gripped by an operator;
a force application member provided on a distal end side of the handle;
an attachment member provided on a rear end side of the handle; and
an electronic tag attached to the attachment member or a rear end portion of the handle, and provided continuously or intermittently along a circumferential direction.

2. The tool according to claim 1, wherein
a groove is continuously or intermittently formed on an outer peripheral surface of the attachment member along the circumferential direction, and
the electronic tag is provided in the groove.

3. The tool according to claim 2, wherein the groove is continuously provided over an entire circumference of the outer peripheral surface of the attachment member, and the electronic tag is wound around the attachment member along the groove.

4. The tool according to claim 2, further comprising a seal member that keeps the groove airtight.

5. The tool according to claim 2, wherein
the attachment member is made of metal,
the tool further comprises a non-metallic spacer provided in the groove, and
the electronic tag is attached to the attachment member via the spacer.

6. The tool according to claim 1, wherein the attachment member is made of resin.

7. The tool according to claim 1, wherein the rear end portion of the handle has an accommodation space that accommodates the electronic tag.

8. The tool according to claim 7, wherein the accommodation space is a space obtained by recessing a rear end surface of the handle.

9. The tool according to claim 7, further comprising an annular substrate provided in the accommodation space,
wherein the electronic tag has an annular shape provided on the substrate.

10. The tool according to claim 1, wherein the electronic tag is provided on a closing surface that closes a rear end opening of the handle in the attachment member.

11. The tool according to claim 10, wherein the electronic tag is accommodated in an accommodation space obtained by recessing the closing surface.

12. The tool according to claim 1, further comprising a tubular spacer fitted into the handle through a rear end opening of the handle,
wherein the attachment member is inserted into the tubular spacer.
